(19) United States
(12) Patent Application Publication
(10) Pub. No.: US 2024/0298585 A1
(43) Pub. Date: Sep. 12, 2024

(54) STACKABLE TOWER PLANTER

(71) Applicant: The Hydro Source Inc., El Monte, CA (US)

(72) Inventors: Keith Thai, El Monte, CA (US); Christopher Bessette, El Monte, CA (US)

(21) Appl. No.: 18/119,557

(22) Filed: Mar. 9, 2023

(51) Int. Cl. A01G 27/00; A01G 9/02; A01G 27/04

(52) U.S. Cl. CPC A01G 27/005; A01G 9/023; A01G 9/028; A01G 27/008; A01G 27/04

(57) ABSTRACT

A stackable tower planter includes a planter bucket having an open top and a hollow interior defined by a side wall and a bottom wall. The planter bucket includes a plurality of irrigation conduits that are disposed along an inner surface of the side wall. Each irrigation conduit has an open top end and an open bottom end that is disposed above the bottom wall of the planter bucket for delivering water to a water reservoir space located along the bottom wall. The stackable tower planter further includes a soil tray disposed within the hollow interior along a bottom of the planter bucket, with the water reservoir space being located below the soil tray. A water tray is coupled to a top edge of the planter bucket. The water tray has a plurality of drain openings that are fluid communication with a plurality of hollow bosses that are located along an underside of the water tray. The hollow bosses are inserted into the open top ends of the plurality of irrigation conduits to fluidly connect a top water collection space of the water tray with the water reservoir space.

### TECHNICAL FIELD

The present disclosure relates to garden planters in which plants can be grown, and more particularly, to planter that has a self-contained irrigation system and is configured to be stacked in a nested arrangement to form a tower planter (vertical planter).

### BACKGROUND

A popular hobby is to grow and maintain small and large plants including, but not limited, to house plants, vegetables, herbs, flowers, crops, etc. For people with yards, a garden can be created and maintained outdoors using the ground soil and/or a garden bed structure, including a raised garden. Unfortunately, many people don't have access to an outdoor garden space and thus, can only grow plants in containers that are placed indoors or can be placed on a balcony or deck or roof or other small outdoor space.

In its simplest form, container gardening requires only a container and soil, such as potting soil. Seeds, seedlings or more mature plants are placed into the soil. Just as with a standard garden bed, container gardeners should keep in mind things such as sunlight exposure, water accessibility, and protection from wind when deciding where to put your containers. When growing vegetables, the container should be placed in an area that gets full sun. However, other plants including some vegetables prefer less light, such as partial sun and even shade. Lettuce, spinach, and other greens can grow well in less sunlight (3 to 5 hours per day), but for fruiting plants like tomatoes, peppers, squash, or eggplant, full sun should be the goal. Southern and western exposures will provide the most sunlight and warmth, while northern and eastern exposures will be shadier and cooler.

Besides sun, water is necessary to sustain plant health and growth. Keep in mind that container gardens tend to need more water than standard in-ground gardens. Conventionally, water is delivered to the container with a watering can. Soil moisture can be monitored with a probe. One type of container is a self-watering planter that uses sub-irrigation to deliver water directly to plant roots, without any guess work. The water reservoir at the bottom of the planter allows the plant to drink at its own pace and visually shows caregivers when it is time to water with an empty reservoir.

For people without yards, limited outdoor space can limit the number of containers that can be placed side-by-side. This limitation spurned a new type of planter and in particular. vertical planters of a stackable type that allows for vertical gardening which is a great way to grow in a small space.

While existing products are satisfactory, there is a need to provide an improved vertical planter of a stackable type.

### SUMMARY

According to one embodiment, a stackable tower planter includes a planter bucket having an open top and a hollow interior defined by a side wall and a bottom wall. The planter bucket includes a plurality of irrigation conduits that are disposed along an inner surface of the side wall. Each irrigation conduit has an open top end and an open bottom end that is disposed above the bottom wall of the planter bucket for delivering water to a water reservoir space located along the bottom wall. The stackable tower planter further includes a soil tray disposed within the hollow interior along a bottom of the planter bucket, with the water reservoir space being located below the soil tray. A water tray is coupled to a top edge of the planter bucket. The water tray has a plurality of drain openings that are fluid communication with a plurality of hollow bosses that are located along an underside of the water tray. The hollow bosses are inserted into the open top ends of the plurality of irrigation conduits to fluidly connect a top water collection space of the water tray with the water reservoir space.

In one embodiment, there are two or more planter buckets in stacked arrangement, with each planter bucket including one soil tray and the stackable tower planter including only one water tray. The two or more planter buckets comprises a bottommost planter bucket, a middle planter bucket and a topmost planter bucket, wherein each of the topmost planter bucket, the middle planter bucket and the bottommost planter bucket further includes a plurality of secondary irrigation conduits that function as overflow conduits. Each second irrigation conduit extends below an underside of the respective planter bucket so as to define hollow nubs. The hollow nubs of the topmost planter bucket are received within the plurality of irrigation conduits of the middle plater bucket to fluidly connect the water reservoir space of the topmost bucket to the plurality of irrigation conduits of the middle bucket and the hollow nubs of the middle planter bucket are received within the plurality of irrigation conduits of the bottommost plater bucket to fluidly connect the water reservoir space of the middle bucket to the plurality of irrigation conduits of the bottommost planter bucket.

The hollow bosses of the water tray are received within the open top ends of the plurality of irrigation conduits of the topmost planter bucket. The water tray includes a raised center dome and the plurality of drain openings are located in fingers that extend outwardly from the center dome. The bottom wall of each of the topmost planter bucket, the middle planter bucket and the bottommost planter bucket includes a raised center hub that includes a water flow conduit defined by an upper hollow nipple that extends upwardly from the raised center hub and a lower hollow nipple that is accessible along an underside of the respective planter bucket and the stackable tower planter further includes a plurality of water feed conduits, with one water feed conduit being fluidly connected between the upper nipple of the bottommost planter bucket and the lower nipple of the middle planter bucket and another water feed conduit being fluidly connected between the upper nipple of the middle most planter bucket and the lower nipple of the topmost planter bucket, thereby fluidly connecting the lower nipple of the bottommost planter bucket and the water reservoir space of the topmost planter bucket. In addition, a water diffuser nozzle is fluidly connected to the upper nipple of the topmost planter bucket for directing water in a radially outward manner within the water reservoir space of the topmost planter bucket.

### BRIEF DESCRIPTION OF THE DRAWING FIGURES

FIG. 1 is a perspective view of a stackable tower planter according to a first embodiment;

FIG. 2 is an exploded side view thereof;

FIG. 3 is a side elevation view thereof;

FIG. 4 is a cross-sectional view taken along the line B-B of FIG. 3

FIG. 5 is a side elevation view thereof;

FIG. 6 is a cross-sectional view taken along the line D-D of FIG. 5;

FIG. 7 is a perspective view of a planter bucket of the stackable tower planter;

FIG. 8 is a side elevation view thereof;

FIG. 9 is a cross-sectional view taken along the line A-A of FIG. 8;

FIG. 10 is a side elevation view thereof;

FIG. 11 is a cross-sectional view taken along the line B-B of FIG. 10;

FIG. 12 is another perspective view thereof;

FIG. 13 is a top plan view thereof;

FIG. 14 is a bottom plan view thereof;

FIG. 15 is a perspective view of a wicking soil tray of the stackable tower planer;

FIG. 16 is another perspective view thereof;

FIG. 17 is a top plan view thereof;

FIG. 18 is a bottom plan view thereof;

FIG. 19 is a perspective view of a water tray of the stackable tower planer;

FIG. 20 is another perspective view thereof;

FIG. 21 is a top plan view thereof;

FIG. 22 is a perspective view of a stackable tower planter according to a second embodiment;

FIG. 23 is an exploded side view thereof;

FIG. 24 is a side elevation view thereof;

FIG. 25 is a cross-sectional view taken along the line A-A of FIG. 24;

FIG. 26 is a side elevation view thereof;

FIG. 27 is a cross-sectional view taken along the line C-C of FIG. 26;

FIG. 28 is a perspective view of a water diffuser nozzle;

FIG. 29 is a side elevation view thereof;

FIG. 30 is cross-sectional view taken along the line A-A of FIG. 29; and

FIG. 31 is a perspective view of a bucket plug.

### DETAILED DESCRIPTION OF CERTAIN EMBODIMENTS

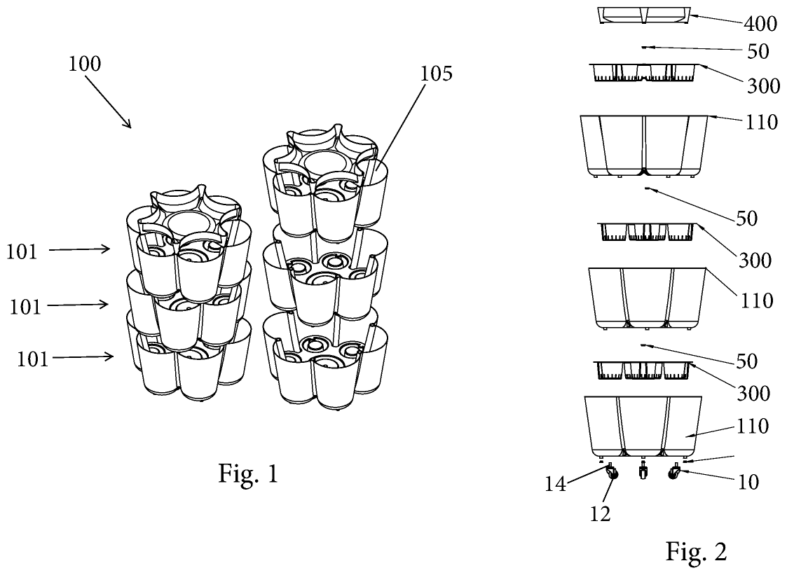

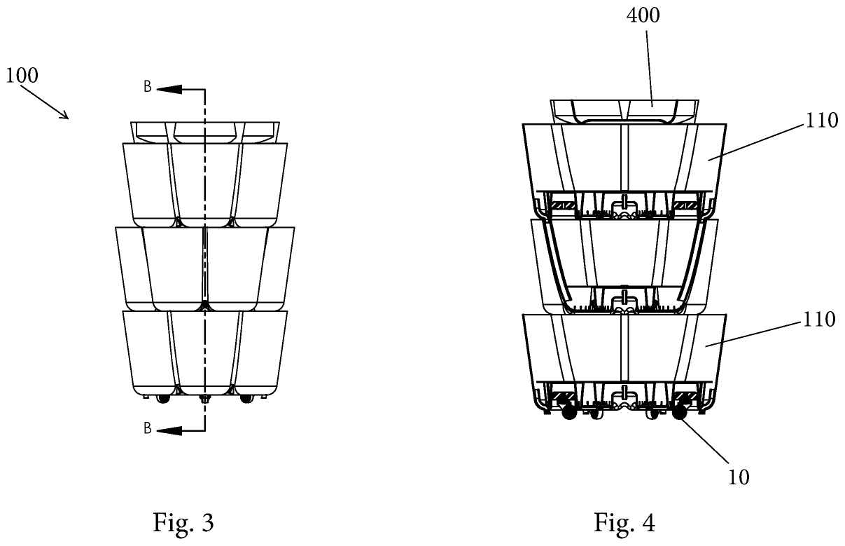

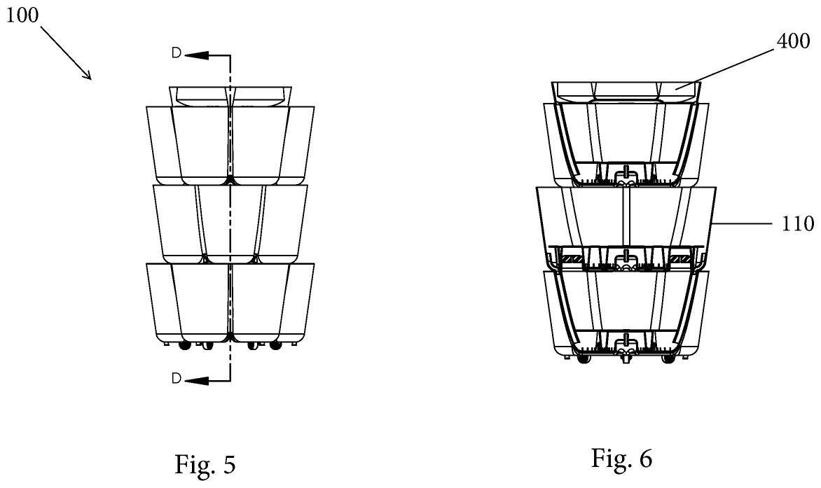

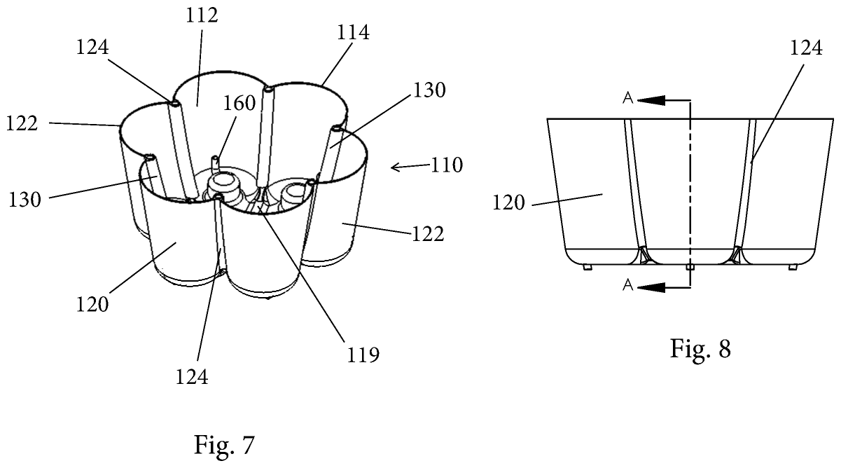

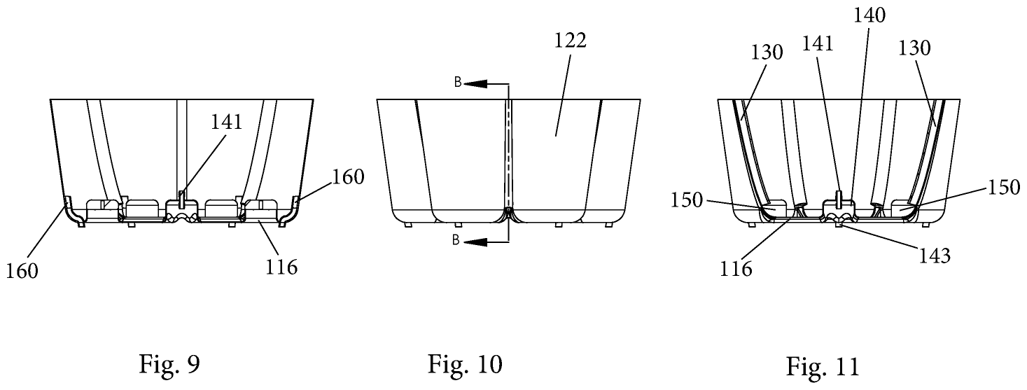

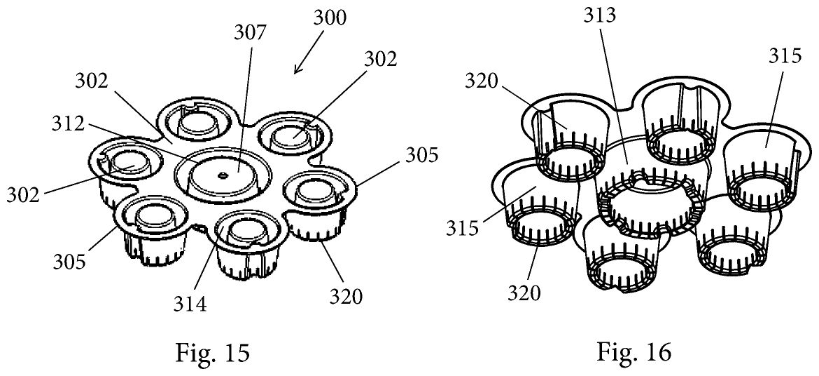

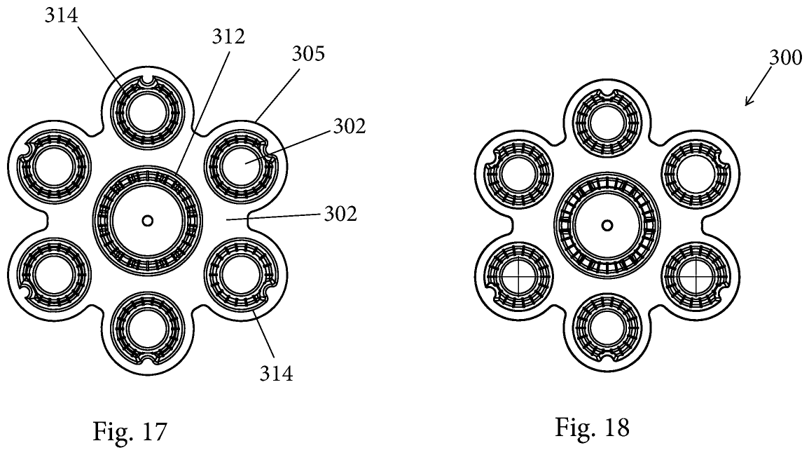

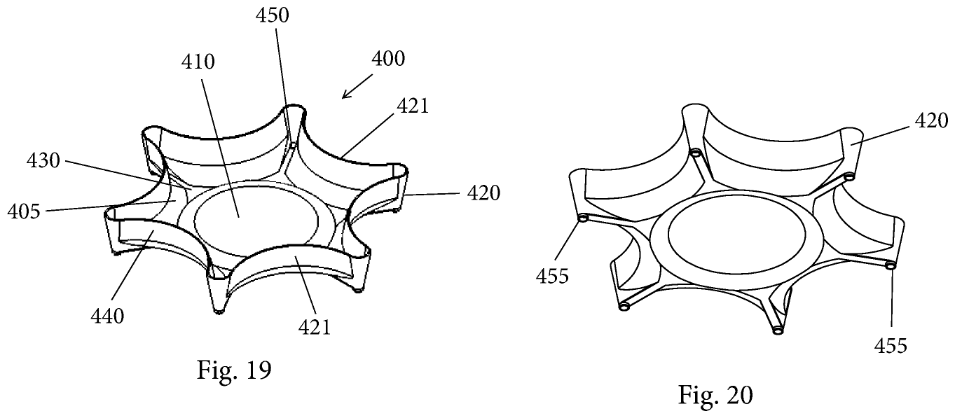

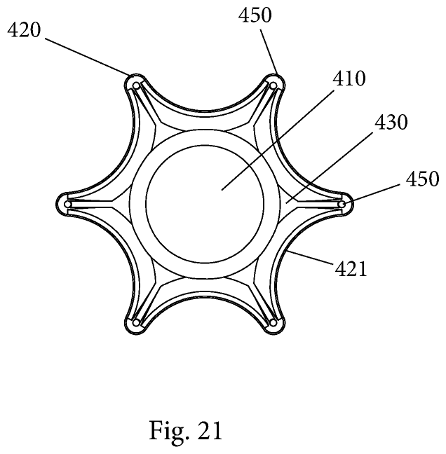

FIGS. 1-21 illustrate a vertically stackable tower planter 100. The tower planter 100 can also be referred to as being a stackable plant tower or a vertical planter. As discussed herein, the tower planter 100 is formed of a number of modular parts (modules) that are adapted for assembly and such that a plurality of modules can be arranged vertically in a stacked arrangement, thereby forming the tower planter 100. In addition, the modules are configured such that they can be at least partially nested together to save space for shipping and storage. In FIG. 1, the modules comprise tower planter modules that are generally identified at 101 and can be formed of one or more assembled parts that are configured for stacking. It will be understood that the tower planter modules 101 can have any geometric shape and in one embodiment, the tower planter modules 101 are lobate or scalloped shape. As discussed in more detail below, the tower planter module 101 includes means for holding soil and also means for water management that can direct a flow of water to each of the tower planter modules 101.

Each of the parts of the stackable tower planter 100 is described below. As mentioned herein, in one embodiment, a single tower planter module 101 can be used and that reflects a non-stacking version of the disclosed product, while the stacked version comprises two or more tower planter modules 101 that are stacked.

Planter Bucket 110

The main component of the tower planter 100 and, in particular of the tower planer module 101 thereof, is a planter bucket 110. The planter bucket 110 is the component that houses and contains other components of the tower planter 100, as well as holding the soil and plants. As mentioned, the planter bucket 110 can have a scallop (petal) or lobate shape; however, other shapes are possible. The planter bucket 110 is a hollow structure as shown and defines a hollow interior 112. The planter bucket 110 has an open top defined by a top edge 114 and a closed bottom defined by a bottom wall (a floor) 116. The planter bucket 110 is defined by a plurality of lobes 120 that are arranged circumferentially. In the illustrated embodiment, the planter bucket 110 has six (6) lobes 120. Each lobe 120 has a curved outer wall 122 with the curved walls 122 of the lobes 120 intersecting one another at a plurality of inflection regions 124. At each inflection region 124, there is a curved outer surface or wall. The curved outer walls 122 of the lobes 120 have convex shapes, while the curved outer surfaces of the inflection regions 124 are concave in shape.

Along an inner surface of the planter bucket 110 at the inflection regions 124 between the lobes 120 there are a plurality of (primary) irrigation conduits 130 that are part of the water management system. The plurality of irrigation conduits 130 are thus arranged circumferentially along the inner surface of the planter bucket 110 and, as shown, can be evenly spaced apart.

The irrigation conduits 130 can be integrally formed with the side wall of the planter bucket 110 (e.g., as part of a molded structure). Each irrigation conduit 130 comprises a (circular) tubular structure that extends from the top edge 114 to a location that is spaced upward from the bottom wall 116. In other words, each irrigation conduit 130 does not extend all the way to the bottom wall 116. Water flowing through the irrigation conduit 130 from the top edge 114 thus exits the irrigation conduit 130 and flows out onto a top surface (floor) of the bottom wall 116.

The bottom wall 116 includes a number of features and in particular, includes a number of raised features that are arranged along the bottom wall 116 and protrude upwardly toward the top edge 114. More particularly, as illustrated, the bottom wall 116 can includes a raised center hub 140 that have centrally located along the bottom wall 116 and can have a circular shape. As shown in the cross-sectional view, the raised center hub 140 functions also as a water conduit (i.e., a bottom water conduit). This bottom water conduit is defined by an upper nipple 141 that protrudes upward into the hollow interior of the planter bucket 110 and a lower nipple 143 that protrudes downwardly and is accessible along a bottom face of the bottom wall 116. The upper and lower nipples 141, 143 can have different shapes includes a conventional circular tubular shape.

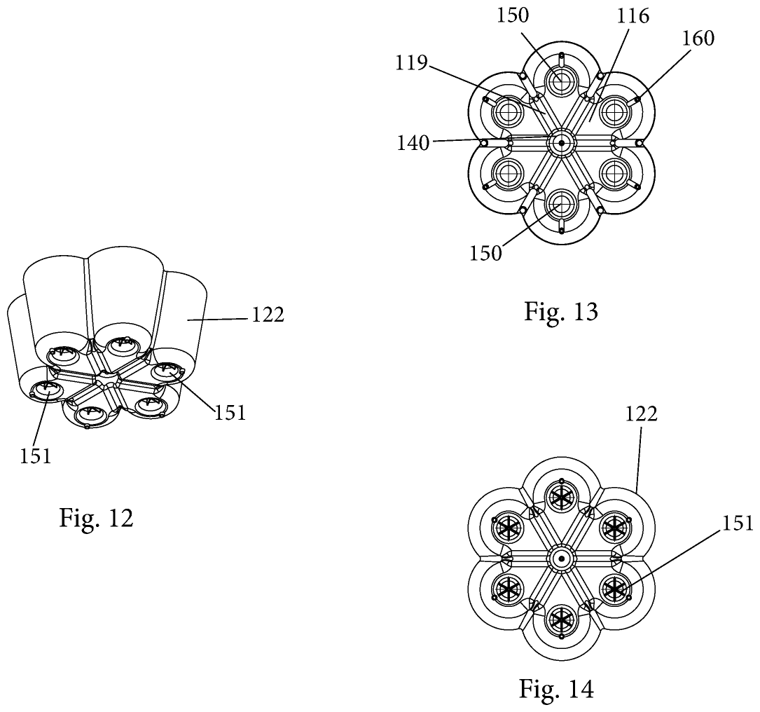

In addition, the bottom wall 116 includes a plurality of raised satellite hubs 150 that are disposed radially outward and circumferentially about the raised center hub 140. These raised satellite hubs 150 are shaped protrusions that extend upwardly within the hollow interior. For example, the raised satellite hubs 150 can have circular shapes. The size of the raised satellite hubs 150 can be the same, similar to different than the size of the raised center hub 140. Unlike the raised center hub 140, the raised satellite hubs 150 do not have any conduit liquid flow through functionality. Along the underside of the bottom wall 116, there is an inverse construction in that at the locations of the raised satellite hubs 150, there are a plurality of recessed areas (cavities) 151 (FIGS. 12 and 14). The shape and size of each recessed area 151 mirrors, in an inverse manner, that of the raised satellite hub 150.

As shown in FIGS. 2 and 4, the plurality of recessed areas 151 are configured so that they can receive a plurality of swivel casters 10 in a detachable manner. In the illustrated embodiment, there are six swivel casters 10. Each swivel caster 10 includes a wheel 12 and a post 14. The post 14 is received within a hole formed centrally within the recessed area 151 to couple the swivel caster 10 to the underside of the bottom wall 116. It will be understood that the use of the swivel casters 10 is optional and permits the entire tower planter 100 to be easily moved in a wheeled manner. When coupled to the planter bucket 110, the plurality of swivel casters 10 are partially located within the recessed areas 151 and are partially outside so as to contact the ground surface. Typically, a friction or press-fit can be used to couple the swivel casters 10 to the planter bucket 110.

As shown, the raised satellite hubs 150 are oriented between the irrigation conduits 130. For example, each satellite hub 150 can be centrally located between two irrigation conduits 130.

Along the top surface of the bottom wall 116 there are a plurality of raised spokes 119 that extend radially outward from the raised center hub 140 and are oriented circumferentially about the raised center hub 140. In the illustrated embodiment, there are six (6) raised spokes 119. The raised spokes 119 are aligned with the irrigation conduits 130 in that one raised spoke 119 extends radially outward from the raised center hub 140 to one irrigation conduit 130. The bottom end of the irrigation conduit 130 is above the top surface of the raised spoke 119 and thus, liquid (water) exiting the irrigation conduit 130 contacts the raised spoke 119. The raised spoke 119 can include angled surfaces for directing the liquid to the lower floor (top surface of the bottom wall 116).

Between the irrigation conduits 130 within the lobes there are secondary irrigation conduits 160 that are tubular structures open at top and bottom ends thereof. These secondary irrigation conduits can be thought of as being overflow tubes as discussed herein. The secondary irrigation conduits 160 have a selected height which, as discussed herein, is based on the water management system. Each secondary irrigation conduit 160 has a first length that is located above the inner surface of the bottom wall 116 (i.e., floor of the planter bucket 110) and a second length that is located below an underside of the bottom wall 116. The second length is much shorter than the first length and therefore, the second length of the secondary irrigation conduit 160 below the underside resembles a small boss or hollow foot. As described herein, these secondary irrigation conduits 160 serve as a means for directing liquid (water) from one planter bucket 110 to another planter bucket 110 located below the one planter bucket 110 (by gravity). The secondary irrigation conduits 160 are located along the inner face of the outer vertical wall of the planter bucket 110 between the raised satellite hubs 150 and the outer vertical wall. In addition, as shown in the cross-section, each secondary irrigation conduit 160 can have a bent or curved shape (S-shaped).

The height of the secondary irrigation conduits 160 are selected so that the heights of the secondary irrigation conduits 160 are taller than the heights of the raised center hub 140 and the raised satellite hubs 150. As described herein, the heights of the secondary irrigation conduits 160 are selected to function as drains to deliver water to an underlying planter bucket 110. In particular, water collects in the bottom of the planter bucket 110 and builds in volume until the height of the collected water reaches the open top ends of the secondary irrigation conduits 160. Once the collected water reaches this level, the water then flows into the secondary irrigation conduits 160 and exits at the bottom ends thereof. The secondary irrigation conduits 160 thus limits the volume of water that is allowed to collect in the bottom of the planter bucket 110 (within the water reservoir space).

The secondary irrigation conduits 160 can have a height of 3 inches as measured from the bottom wall 116. The open top end of each secondary irrigation conduit 160 is located higher than the open bottom end of the irrigation conduit 130 as shown.

As mentioned, the planter bucket 110 can be formed as a single molded plastic structure; however, other materials are possible.

Wicking Soil Tray 300

The stackable tower planter 100 also includes a wicking soil tray 300. The wicking soil tray 300 is configured to sit within the planter bucket 110 at the bottom of the planter bucket 110 (along the bottom wall 116). The wicking soil tray 300 has a flat top surface 302. The wicking soil tray 300 also has a lobate shape and is defined by a plurality of lobes 305 that protrude outwardly from a center section 307. The wicking soil tray 300 is constructed so that there is a plurality of recessed wells 310. In particular, the plurality of wells 310 include a center well 312 and a plurality of satellite wells 314 that are formed radially outward from the center well 312. The center well 312 is sized larger than the satellite wells 314. Each of the center well 312 and the satellite wells 314 has an annular shape in that the center of the well defines the flat top surface 302. The satellite wells 314 are located within the plurality of lobes 305.

The center well 312 is defined by a first annular shaped wall 313 and each of the satellite wells 314 is defined by a second annular shaped wall 315. Each of the first annular shaped wall 313 and the second annular shaped wall 315 includes wicking slits 320. The wicking slits 320 are located at the bottom region of the respective wall and are designed to permit a water wicking action since, as discussed herein, the water reservoir in the planter bucket 110 lies below the wicking slits 320 (below the wicking soil tray 300).

As shown in the figures, the center well 312 includes a center opening 315 that passes through the top center surface of the center well 312.

As shown in the bottom perspective view of FIG. 16, the underside of the wicking soil tray 300 has an inverse shape compared to the top appearance of the wicking soil tray 300. In particular, the underside of the center well 312 and each of the satellite wells 314 is defined by an open space that is defined by and located within the respective first and second annular shaped walls 313, 315. The size of this open space is specifically tailored in view of the raised center hub 140 and the raised satellite hubs 150 and more particularly, the wicking soil tray 300 is designed to be inserted into the hollow interior of the planter bucket 110. The raised center hub 140 is received within the open space below the center well 312 and the raised satellite hubs 150 are received within the open spaced below the satellite wells 314.

As the name suggests, the wicking soil tray 300 is designed to hold the soil of the planter and wick water to the soil and more particularly, after the wicking soil tray 300 is inserted into the planter bucket 110, soil is placed along the top surface of the wicking soil tray 300. The center well 312 and satellite wells 314 extend downward into the water reservoir and thereby provides a water wicking action through the wicking slits 320, whereby water from the water reservoir is wicked up to the soil for wetting thereof.

The tower planter 100 also includes a water tray 400. The water tray 400 is generally star shaped with a center region 410 and a plurality of fingers 420 that extend radially outward from the center region 410. The water tray 400 is defined by a bottom wall 430 and a perimeter side wall 440 that extends around the perimeter of the bottom wall 430. The bottom wall 430 is located at the bottom of the perimeter side wall 440 and therefore, the bottom wall 430 is recessed relative to a top edge 442 of the perimeter side wall 440 so as to define a tray that can collect and hold water. In other words, the water tray 400 defines a water collection space 405 located along the top face of the water tray 400.

Between each pair of fingers 420, there is a curved outer edge 421 and in particular, this curved outer edge 421 has a concave shape.

The center region 410 has a dome-like shape which promotes water flow from the center radially outward to the plurality of fingers 420. In other words, a user can pour water onto the top of the dome-shaped center region 410 and the water will flow radially outward toward the plurality of fingers 420. Within each finger 420 there is a drain opening 450 that is a through hole that permits water to exit the recessed top tray section and flow in a downward direction. In the drawings, the drain opening 450 is shown as a circular hole. The drain openings 450 are thus located lower than the top of the dome-shaped center region 410 and water flows by gravity to the drain openings 450.

Along the underside of the water tray 400 the drain openings 450 terminate at small hollow bosses 455 or nubs. As described herein, these bosses 455 act as coupling members that are part of the water management system and more specifically, allow for the water tray 400 to be coupled to the planter bucket 110 (i.e., to the open ends of the irrigation conduits 130). This action is discussed below in the assembly steps. As shown, when the water tray 400 attaches to the water bucket 110, the concave shaped outer edge 421 faces the convex shaped curved outer wall 122 of the planter bucket 110 so as to create a plant opening (space) or pocket 105 (FIG. 1). This pocket 105 is intended to identify an area that a plant should be planted and permitted to grow upward. Thus, there are six pockets 105 that define six discrete growing or planting areas. Each of these areas (pockets 105) are separated from one another and thus, the plants are separated from one another.

It will also be appreciated that between the water tray 400 and the soil tray 300 there is an air gap. The air gap is used to air prune the roots so that the roots don't go into the water tray. Whenever a root is exposed to air or light, it will naturally stop growing at that point. From that point on the root before the exposed point will branch out and create feeder roots. This also helps with the plants development as feeder roots tend to absorb nutrients better and have more surface area to absorb nutrients and water.

Assembly of Single Planter

As mentioned, the stackable tower planter 100 is made up of one or more modules 101. In its simplest form, there is only a single module 101 and thus, there is no stacking. When two or more modules 101 are used, a stacked tower planter 100 results. Each module 101 comprises one planter bucket 110, one wicking soil tray 300, and one water tray 400. To assembly, the wicking soil tray 300 is inserted into the hollow interior of the planter bucket 110 resulting in the wicking soil tray 300 sitting on the bottom wall 116. As mentioned, the raised center hub 140 is received within the open space below the center well 312 and the raised satellite hubs 150 are received within the open spaced below the satellite wells 314.

Once the wicking soil tray 300 is in place, soil can be added. Soil rests on top of the wicking soil tray 300. Soil can be added so that it substantially fills up the planter bucket 110 but does not extend to the top edge of the planter bucket 110. Seeds, seedlings and/or plants are placed in the soil with one or more pockets 105.

The water tray 400 is placed above the top edge of the planter bucket 110 and the water tray 400 is oriented so that bosses 455 are inserted into the open top ends of the plurality of irrigation conduits 130, thereby fluidly connecting the drain openings 450 with the plurality of irrigation conduits 130. This coupling establishes a fluid pathway from the water collection space 405 of the water tray 400 to the water reservoir located in the bottom of the planter bucket 110 (that is below the wicking soil tray 300). More specifically, the water that is added to the water tray 400 flows outward to the drain openings 450 and then flows down these drain openings 450 into the plurality of irrigation conduits 130. Within the plurality of irrigation conduits 130, the water flows by gravity downward and then exits into the bottom of the planter bucket 110.

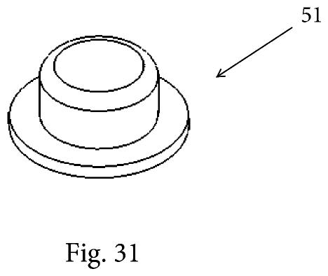

A thru hole plug 50 can be provided for plugging the lower nipple 143 to prevent any water from flowing out of the bottom water reservoir in the planter bucket 110 when the bottom water conduit 145 is not in use (see discussion herein concerning the situational use of this conduit). It is also possible that plugs can be used to plug the secondary irrigation conduits 160; however, as discussed herein, these secondary irrigation conduits 160 function as overflow tubes and thus, protect against a situation in which the planter is overwatered which can lead to damage to the plants. For example, bucket plugs 51 (FIGS. 23 and 31) can be used to plug the secondary irrigation conduits 160 (in bottom most bucket). In addition, one or more of the second irrigation conduits 160 can be connected to a drain tube (not shown) that is connected to the end of the secondary irrigation conduits 160 that lie below the bottom of the planter bucket 110. This drain tube would allow for excess water to be directed to another location such as another planter or a drain, etc. It will also be appreciated that some people prefer to leave the secondary irrigation conduits 160 open since it is a way to understand when an overflow conditions results. For example, if the user overfills the bottom water reservoir, water will flow out of the secondary irrigation conduits 160 and this alerts the user to stop watering the planter. In other words, when water exits the bottom ends of the secondary irrigation conduits 160, the bottom water reservoir is filled. When casters are not used, these plugs in the secondary irrigation conduits 160 can acts as feet for the planter.

Assembly of Tower Planter

To assemble the tower planter 100, a plurality of modules 101 are stacked to form the tower. The bottom module 101 includes one planter bucket 110 and one wicking soil tray 300 installed in the manner described above. The planter bucket 110 of the bottom module 101 will be described herein as being the bottom planter bucket 110.

Next instead of installing the water tray 400 on top of this bottom module 101, a second planter bucket 110 is coupled to the bottom planter bucket 110. The coupling is accomplished by rotating the second planter bucket 110 and aligning the secondary irrigation conduits 160 with the irrigation conduits 130 of the bottom planter bucket 110. In fact, the second planter bucket 110 is coupled to the bottom planter bucket 110 by inserting the bottom exposed ends of the secondary irrigation conduits 160 into the top open ends of the irrigation conduits 130 of the bottom planter bucket 110. As shown, this coupling results in the lobes of the second planter bucket 110 being rotationally offset from the lobes of the bottom planter bucket 110. By connecting the secondary irrigation conduits 160 to the irrigation conduits 130, water entering the top ends of the secondary irrigating conduits 160 (overflow tubes) in the second planter bucket 110 flows into the irrigation conduits 130 of the bottom planter bucket 110 to the bottom water reservoir in the bottom planter bucket 110. It will therefore be appreciated that the water management system functions by first filling the bottom water reservoir of the top modules 101 and then successively filling the lower modules 101 until the bottommost module 101 is filled. This action is described in more detail herein.

One wicking soil tray 300 is installed into the second planter bucket 110 in the manner described herein.

If the tower planter 100 only includes two modules 101, then once the second planter bucket 110 is installed on the bottom planter bucket 110 and the wicking soil tray 300 is installed, the water tray 400 is installed on the second planter bucket 110. Installing the water tray 400 on the second planter bucket 110 is accomplished as described herein in that the hollow bosses 455 are inserted into the open top ends of the irrigation conduits 130 of the second planter bucket 110.

FIGS. 1-21 illustrate one tower planter 100 that comprises three stacked modules 101. The stacking of each module 101 is the same described above in that the secondary irrigation conduits 160 of the overlying planter bucket 110 are fluidly connected to the irrigation conduits 130 of the underlying bucket 110. In this way, once the bottom water reservoir of the upper planter bucket 110 is filled, the collected water flows into the top open ends of the secondary irrigation conduit 160 (overflow tubes) and into the irrigation conduits 130 of the underlying planter bucket 110 for filling of that bottom water reservoir. The process repeats itself in that once the water level in the bottom water reservoir of one planter bucket 101 reaches a predetermined level (e.g., 3 inches) indicative of the bottom water reservoir being filled, the water flows into the secondary irrigation conduit 160 (overflow tubes) and then into the irrigation conduits 130 of the underlying planter bucket 110 for filling of the bottom water reservoir of that planter bucket 110.

The topmost module 101 includes the water tray 400 that is coupled to the top edge of the planter bucket 101 of the topmost module 101. Thus, in one embodiment, the water management system includes the user pouring water into the water tray 400, whereby the water flows radially outward to the fingers and to the drain openings 450. The water flows within the drain openings 450, by gravity, through the irrigation conduits 130 that are fluidly coupled to the drain openings 450 and to the bottom water reservoir of the topmost planter bucket 110. This results in filling of this bottom water reservoir of the topmost planter bucket 110 and then once the bottom water reservoir is filled, the collected water flows into the secondary irrigation conduits 160, which again act as overflow tubes, whereby this overflow water then flows directly into the irrigation conduits 130 of the underlying planter bucket 110 for filling of the bottom water reservoir of this underlying planter bucket 110. This water filling process repeats until the bottom water reservoir of the bottommost plater bucket 110. It will therefore be appreciated that the water supply to the modules 101 occurs in a sequential manner from the top down in the embodiment shown in FIGS. 1-21.

Assembly of Tower Planter (Reverse Water Feed)

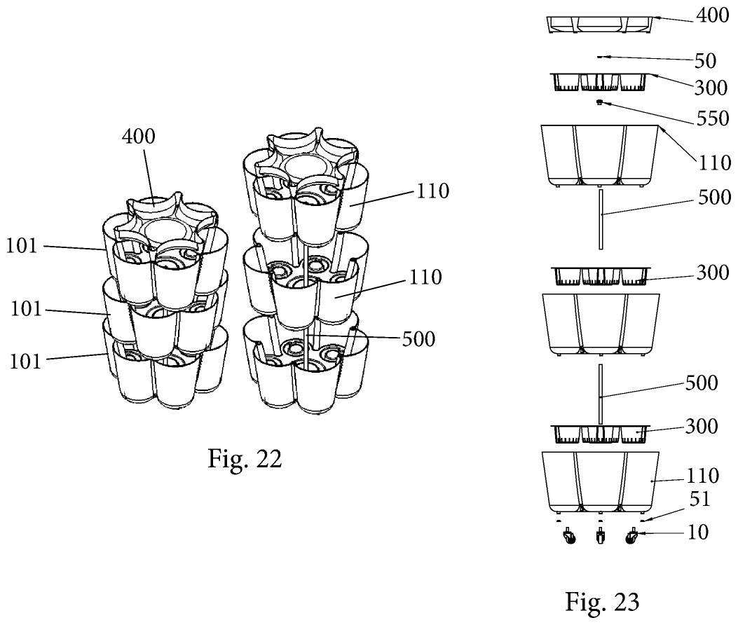

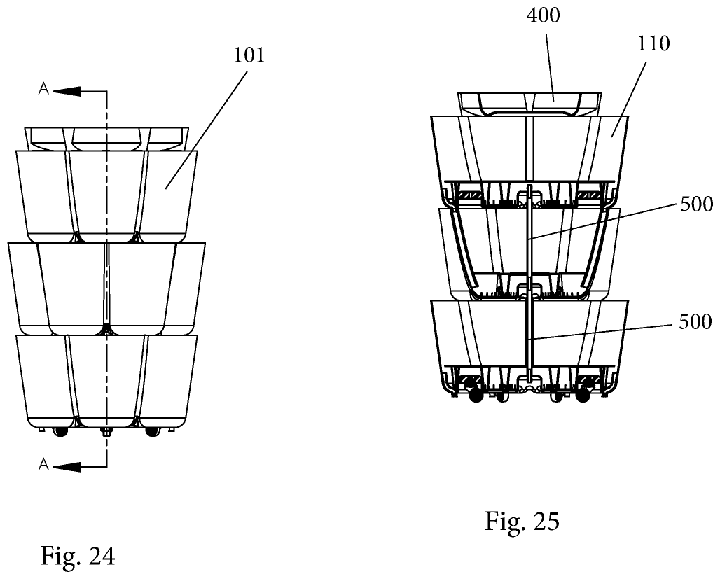

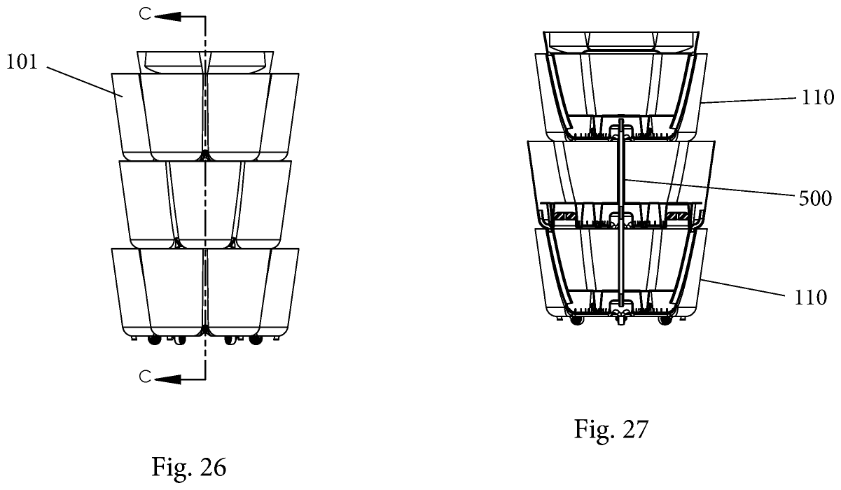

FIGS. 22-27 illustrate another embodiment that has a different water management system and more particularly, has a different water feed architecture. As discussed herein, in this embodiment, the water is not introduced first to the water tray 400 of the topmost module 101 but rather is introduced to the bottommost planter bucket 110 of the bottom module 101. In this reverse water feed, the water flows upward, under force, from the bottom module 101 to the top module 101.

In this embodiment, one or more water feed conduits 500 are provided. Each water feed conduit 500 can be in the form of a through tube (e.g., plastic tube). The water feed conduits 500 are configured to fluidly connect one planter bucket 110 to another planter bucket 110. More particularly, one end of the water feed conduit 500 is fluidly connected to the upper nipple 141 of one planter bucket 110 (FIG. 11) and the other end is connected to the lower nipple 143 of the planter bucket 110 (FIG. 11) that is immediately above the one plater bucket 110. This process is repeated between the modules 101. The center wicking well 302 includes a center wall with a center opening formed therethrough to permit passage of the water feed conduit 500 therethrough.

For example, in FIGS. 22-27, where there are three planter buckets 110, there are two water feed conduits 500, one between the bottom planter bucket 110 and the middle planter bucket 110 and the other water feed conduit 500 between the middle planter bucket 110 and the top planter bucket 110.

In this reverse water feed, a fluid (water) source is connected to the lower nipple 143 of the bottom planter bucket 110 and water is delivered under force (pressure) to the lower nipple 143 and then flow up through the upper nipple 141 to the water feed conduit 500. The water then flows upward through the water feed conduit 500 to the immediately above planter bucket 110. The water flows next into the next water feed conduit 500 which in the illustrated embodiment is in direct fluid communication with the bottom water reservoir in the topmost planter bucket 110.

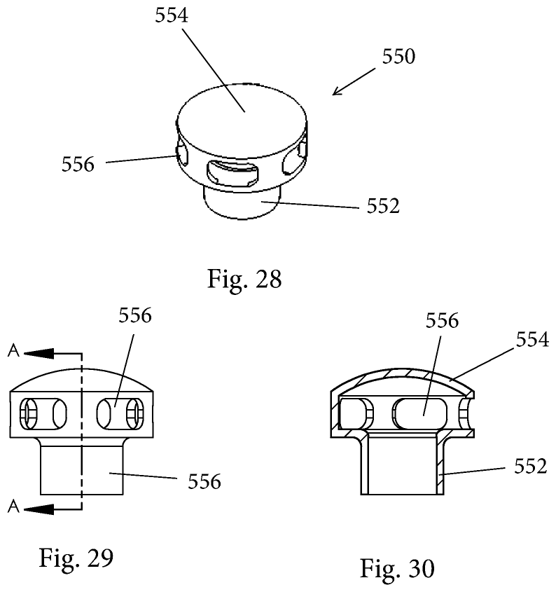

As shown in FIGS. 23 and 28-30, a water diffuser nozzle 550 is provided for attachment to the upper nipple 141 of the topmost planter bucket 110. The water diffuser nozzle 550 includes a hollow stem 552 and a head portion 554 at the top of the hollow stem 552. Along the side of the head portion 554, there are side openings 556 formed circumferentially about the head portion 554. Water that is pumped into the stem 552 flows radially outward through the side openings 556 which serves to spread out the water flow into the bottom water reservoir of the topmost planter bucket 110.

Once the bottom water reservoir is filled in the topmost planter bucket 110, the water then flows to the underlying planter buckets or buckets 110 by the means described herein, e.g., by overflow tubes (secondary irrigation conduits 160).

Accordingly, in this embodiment, the water can be pumped to the bottommost module 101 and then delivered up to the topmost module 101 where the water flows down in succession through the modules 101.

It will be appreciated that the parts the form the modules 101 of the tower planter 100 are modular in nature in that the planter buckets 110 all have the same construction (size and shape) and are merely rotationally offset.

Once again, it will be appreciated that the device disclosed herein can include a single bucket design or can include multiple stacked buckets. For example, the illustrated three bucket design is one embodiment; however, a four or five bucket design is equally possible or more or less buckets are equally possible.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A stackable tower planter comprising:
a planter bucket having an open top and a hollow interior defined by a side wall and a bottom wall, the planter bucket including a plurality of irrigation conduits that are disposed along an inner surface of the side wall, each irrigation conduit having an open top end and an open bottom end that is disposed above the bottom wall of the planter bucket for delivering water to a water reservoir space located along the bottom wall;
a soil tray disposed within the hollow interior along a bottom of the planter bucket, with the water reservoir space being located below the soil tray; and
a water tray coupled to a top edge of the planter bucket, the water tray having a plurality of drain openings that are fluid communication with a plurality of hollow bosses that are located along an underside of the water tray, the hollow bosses being inserted into the open top ends of the plurality of irrigation conduits to fluidly connect a top water collection space of the water tray with the water reservoir space.

2. The stackable tower planter of claim 1, wherein the plurality of irrigation conduits of are integrally formed with the side wall of the planter bucket, the open top ends of the plurality of irrigation conduits being located at the top edge of the planter bucket.

3. The stackable tower planter of claim 1, wherein the plurality of irrigation conduits is circumferentially formed along the inner surface of the side wall.

4. The stackable tower planter of claim 1, wherein the side wall of the planter bucket has a lobate shape defined by a plurality of lobes with inflection regions being located between the plurality of lobes.

5. The stackable tower planter of claim 4, wherein each lobe is defined by a convex shaped outer surface and each inflection region has a concave shaped outer surface.

6. The stackable tower planter of claim 5, wherein plurality of irrigation conduits are located within the inflection regions of the planter bucket.

7. The stackable tower planter of claim 4, wherein the plurality of lobes comprises six lobes.

8. The stackable tower planter of claim 1, wherein the bottom wall of the planter bucket includes a raised center hub that includes a water flow conduit defined by an upper hollow nipple that extends upwardly from the raised center hub and a lower hollow nipple that is accessible along an underside of the planter bucket.

9. The stackable tower planter of claim 8, wherein the bottom wall of the planter bucket includes a plurality of raised satellite hubs that are disposed radially outward and circumferentially about the raised center hub.

10. The stackable tower planter of claim 9, wherein each of the raised center hub and the plurality of raised satellite hubs have circular shapes.

11. The stackable tower planter of claim 9, wherein the bottom wall includes a plurality of raised spokes that extend radially outward from the raised center hub toward the plurality of irrigation conduits.

12. The stackable tower planter of claim 11, wherein each raised spoke has a sloped or angled surface to direct water flow.

13. The stackable tower planter of claim 9, wherein the planter bucket further includes a plurality of secondary irrigation conduits that function as overflow conduits, each second irrigation conduit extending below an underside of the planter bucket so as to define hollow nubs, wherein tops ends of the plurality of secondary irrigation conduits are located above top faces of the raised center hub and the plurality of raised satellite hubs and wherein the open bottom ends of the plurality of irrigation conduits are located below the top faces of the raised center hub and the plurality of raised satellite hubs.

14. The stackable tower plant of claim 13, wherein the water reservoir space is located below the top ends of the plurality of secondary irrigation conduits.

15. The stackable tower planter of claim 1, wherein the planter bucket further includes a plurality of secondary irrigation conduits that function as overflow conduits, each second irrigation conduit extending below an underside of the planter bucket so as to define hollow nubs that are configured to be inserted into top ends of the plurality of irrigation conduits when the stackable tower planter includes more than one planter bucket in stacked arrangement.

16. The stackable tower planter of claim 15, wherein the plurality of secondary irrigation conduits are interspersed between the plurality of irrigation conduits.

17. The stackable tower planter of claim 15, wherein a height of each secondary irrigation conduit is 3 inches as measured from the bottom wall.

18. The stackable tower planter of claim 1, wherein the bottom wall of the planter bucket includes a raised center hub and a plurality of raised satellite hubs that are disposed radially outward and circumferentially about the raised center hub and the soil tray includes a plurality of discrete cavities formed along the underside of the soil tray and configured such that when the soil tray is inserted into the planter bucket, the raised center hub and the plurality of raised satellite hubs are received within the plurality of discrete cavities.

19. The stackable tower planter of claim 1, wherein the soil tray has a lobate shape and includes a center wicking well and a plurality of satellite wicking wells that are formed radially outward from the center wicking well.

20. The stackable tower planter of claim 19, where each of the center wicking well and each of the satellite wicking wells is defined by an annular shaped wall that includes a plurality of wicking slits.

21. The stackable tower planter of claim 20, wherein the center wicking well includes a center wall with a center opening formed therethrough.

22. The stackable tower planter of claim 1, wherein there are two or more planter buckets in stacked arrangement, with each planter bucket including one soil tray and the stackable tower planter including only one water tray.

23. The stackable tower planter of claim 22, wherein the two or more planter buckets comprises a bottommost planter bucket, a middle planter bucket and a topmost planter bucket, wherein each of the topmost planter bucket, the middle planter bucket and the bottommost planter bucket further includes a plurality of secondary irrigation conduits that function as overflow conduits, each second irrigation conduit extending below an underside of the respective planter bucket so as to define hollow nubs, wherein the hollow nubs of the topmost planter bucket are received within the plurality of irrigation conduits of the middle plater bucket to fluidly connect the water reservoir space of the topmost bucket to the plurality of irrigation conduits of the middle bucket and the hollow nubs of the middle planter bucket are received within the plurality of irrigation conduits of the bottommost plater bucket to fluidly connect the water reservoir space of the middle bucket to the plurality of irrigation conduits of the bottommost planter bucket.

24. The stackable tower planter of claim 23, wherein the hollow bosses of the water tray are received within the open top ends of the plurality of irrigation conduits of the topmost planter bucket.

25. The stackable tower planter of claim 24, wherein the water tray includes a raised center dome and the plurality of drain openings are located in fingers that extend outwardly from the center dome.

26. The stackable tower planter of claim 23, wherein the bottom wall of each of the topmost planter bucket, the middle planter bucket and the bottommost planter bucket includes a raised center hub that includes a water flow conduit defined by an upper hollow nipple that extends upwardly from the raised center hub and a lower hollow nipple that is accessible along an underside of the respective planter bucket and the stackable tower planter further includes a plurality of water feed conduits, with one water feed conduit being fluidly connected between the upper nipple of the bottommost planter bucket and the lower nipple of the middle planter bucket and another water feed conduit being fluidly connected between the upper nipple of the middle most planter bucket and the lower nipple of the topmost planter bucket, thereby fluidly connecting the lower nipple of the bottommost planter bucket and the water reservoir space of the topmost planter bucket.

27. The stackable tower planter of claim 26, further including a water diffuser nozzle that is fluidly connected to the upper nipple of the topmost planter bucket for directing water in a radially outward manner within the water reservoir space of the topmost planter bucket.
